(19) United States
(12) Patent Application Publication
(10) Pub. No.: US 2003/0042852 A1
(43) Pub. Date: Mar. 6, 2003

(54) Encapsulation structure, method, and apparatus for organic light-emitting diodes

(76) Inventor: Hwa-fu Chen, Hsinchu (TW)

Correspondence Address: MARTINE & PENILLA, LLP, 710 LAKEWAY DRIVE, SUITE 170, SUNNYVALE, CA, 94085, US

(21) Appl. No.: 10/233,120

(22) Filed: Aug. 30, 2002

(30) Foreign Application Priority Data
Sep. 5, 2001 (JP) JP2001-269601

(51) Int. Cl. H05B 33/04

(52) U.S. Cl. 313/512

(57) ABSTRACT

This invention provides a novel method and apparatus for the encapsulation of OLEDs. Comparing with the conventional encapsulation, the new process is simple, fast, and low-cost. The key structure is a glass or flexible, UV-transmittable encapsulation plate with a specified pattern of bumping lines, which are substitutes for the expensive covers used in the conventional encapsulation. These bumping lines serve not only as continuous walls for sealing each of the enclosed OLED, but also serve as the spacer between the OLED substrate and the encapsulation plate. In addition, these bumping lines are the canals for confining the encapsulating adhesive both at the time when the adhesive is applied and at the time when the adhesive is pressed against both of the OLED substrate and the encapsulation plate for curing. The key advantage of this encapsulation plate, used in the encapsulation of OLDEs, is that we only need one alignment process for encapsulating all the OLEDs in the substrate, compared to the one-by-one placing of hundreds of conventional covers for 370 mm×370 mm substrates. This results in an encapsulation process of OLEDs that is significantly more reliable, more robust, and less time-consuming.

### BACKGROUND OF THE INVENTION

1. Field of the Invention

The invention relates to an encapsulation structure, method, and apparatus for organic light-emitting diodes (OLEDs). An encapsulation plate with a set of closed bumping lines, rather than the conventional covers, is used to encapsulate all the OLEDs in the substrate at once, resulting in an encapsulation process that is significantly more reliable, more robust, and less time-consuming.

2. Description of the Related Art

OLEDs have received much attention in recent years because of their potential application in full color flat panel displays. The OLEDs applied in full color flat panel displays are thin, fully solid light-emitting display elements. The major features of OLED displays are: high quantum efficiency, high luminance with less electric power consumption due to the lack of back light, simple fabrication, and fast response. Recently, the OLEDs have also been applied to produce the OLED flat panel monitors. Conventionally, the OLEDs can be fabricated as a multi-layer structure as described in FIG. 8.

As shown in FIG. 8, the conventional OLED 100 comprises a transparent electrode 120 (anode) situated on a glass or flexible substrate 110 by vacuum evaporating or sputtering. On top of the anode 120, a stack of three organic layers 130 to 150 is thermally evaporated. The organic layer 130 serves as a hole transport layer (HTL) and the organic layer 150 serves as an electron transport layer (ETL). The organic layer 140, which is embedded between the two transport layers 130 and 150, serves as an emissive layer (EL). On top of the ETL 150, a metallic electrode (cathode) 16 is formed by vacuum evaporating. The virtue of a layered structure is that it facilitates carrier injection, balances the transport of electron and holes, and removes the emission region from the metallic contacts. This generally results in higher efficiency and luminance at low operating voltages. Ideally, the operating voltage of a device should be close to its turn-on voltage. This can be achieved if both metallic contacts (anode and cathode) are ohmic and capable of providing trap-free space charge limited (TFSCL) current. However, in reality, the operating voltage is higher than the turn-on voltage and is limited by the low carrier mobility and, in most cases, by the non-ohmic metallic electrodes.

The first OLEDs were very simple in that they comprised of only two or three layers. Recent development leads to OLEDs having many different layers (known as multi-layer devices) each of which is optimized for a specific task. With the multi-layer device architectures now employed, a performance limitation of OLEDs is their lifetime. It has been demonstrated that some of the organic materials are very sensitive to contamination, oxidation, and humidity. Furthermore, most of the metals used as contact electrodes for OLEDs are susceptible to corrosion in air or other oxygen containing environments. Because the lifetime of the OLED is greatly shortened after the OLED is exposed to the ambient oxygen or moisture, it is necessary to have a good encapsulation of the OLED. Therefore, the OLED manufactured in the manufacturing apparatus maintained at high vacuum has to be transferred immediately to an inert gas (such as nitrogen) environment, where it is encapsulated.

Referring to FIGS. 9(a) and 9(b), the conventional encapsulation method for OLEDs is performed by adopting a cover 20 made of glass or metal to cover the glass substrate 2 so as to form OLEDs 3. FIG. 9(a) is a pictorial view showing four OLEDs 3 formed by covering different covers 20. FIG. 9(b) is a cross-sectional view of a part of the structure of FIG. 9(a). An adhesive 22 is applied at the edge portion 21 of the cover 20. Then, as shown in FIG. 9(b), the cover 20 is placed on top over the substrate 2 which contains the OLED 3, and the adhesive is subsequently cured for complete sealing.

There are several problems about this conventional method. First, it is difficult to apply the adhesive without having it running over to nearby region. When the cover 20 is placed on the adhesive, it usually makes the situation worse. The adhesive is compressed to run over into the OLED 3, and thus damages it.

Second, each cover 20 must be designed and produced with the specified shape and geometry. This is because that the cover 20 should not make any contact with the OLED 3 for not having bad influence on the performance of the device. Yet, the cover 20 should be on top of the previously applied adhesive, so that the device will be sealed after curing. This precisely machined or molded covers are often expensive.

Third, as shown in FIG. 9(a), multiple (usually up to 100 depending on the substrate size) OLEDs 3 are fabricated on the substrate 2 according to a specified pattern. It is then necessary to precisely place each cover 20 right on top over the corresponding OLEDs 3. This kind of precise placing can only be achieved by utilizing very sophisticated, vacuum-compatible robot arms, which not only occupy a large chamber space, but also are quite expensive.

Fourth, the placing of about 100 covers one-by-one onto a 370 mm×370 mm substrate take a long time. This will significantly reduce the throughput of the production, and thus increase the manufacturing cost.

### SUMMARY OF THE INVENTION

It is therefore an object of this invention to provide a novel method and apparatus which, compared to the conventional encapsulation, is significantly simple, fast, and low-cost. The structure is a glass or flexible, UV-transmittable encapsulation plate with a set of patterned, closed, bumping lines which are substitutes for multiple covers used in the conventional encapsulation. In the case of a 100 mm×100 mm glass plate, there are four sets of closed, square bumping lines, formed by thick-film printing processes.

These bumping lines serve not only as continuous walls for sealing each of the enclosed OLEDs, but also serve as the spacer between the OLED substrate and the encapsulation plate. In other words, the bumping lines provide all the functions that the conventional covers are used to supply, but do without the latter's expensive machining and molding.

In addition, these bumping lines can also serve as canals for confining the encapsulating adhesive both at the time when the adhesive is applied and at the time when the adhesive is pressed against both of the OLED substrate and the encapsulation plate for curing. This is the important feature that the conventional covers do not have. Because of this deficiency in conventional encapsulation, there is no way for preventing the applied adhesive from running all over to the vulnerable OLED areas.

Moreover, the key advantage of this encapsulation plate is that only one alignment process is needed for encapsulating all the OLEDs in the substrate, compared to the one-by-one placing of hundreds of conventional covers for a 370 mm×370 mm substrate. Hence, the resulting encapsulation process is significantly more reliable, more robust, and less time-consuming.

As for the encapsulation structure of the invention, an encapsulation plate is placed on the substrate to encapsulate the OLEDs formed on the substrate. The encapsulation plate is a glass plate or a flexible, UV-transmittable plastic plate on which at least one closed bumping line is formed for sealing each OLED on the substrate. A glass encapsulation plate is used to encapsulate a glass or hard substrate while a flexible, UV-transmittable encapsulation plate is to encapsulate any flexible substrate. The encapsulation plate is adhered to the substrate using the adhesive to complete the encapsulation.

In the encapsulation method for OLEDS, at least one bumping line for enclosing each OLED on the substrate is previously formed on the surface of the encapsulation plate. Then, the adhesive is applied or coated on the bumping line or between the bumping lines. Next, the encapsulation plate is pressed against the substrate, and the plate and substrate are glued (sealed) together by curing the adhesive. Consequently, the encapsulation process is simple and time saving.

In the encapsulation structure and method for OLEDs, the bumping line may be one bumping line or two to four finely spaced bumping lines. If one single bumping line is used, the adhesive is applied to the top of the single bumping line. When the encapsulation plate is pressed against the substrate, the top-applied adhesive adheres the substrate to the encapsulation plate. If two adjacent bumping lines are used, the adhesive is applied to the canal formed between the two bumping lines. The quantity of the adhesive applied is controlled to just exceed the wall of the canal, but without spilling out. When the encapsulation plate is pressed against the substrate, the canal-confined adhesive adheres the substrate to the encapsulation plate, and the canal walls act as spacers to prevent the encapsulation plate from touching the OLEDs on the substrate. Alternatively, if three adjacent bumping lines are used, the adhesive is applied to the outer canal and the inner canal is used to provide an extra safety trench for containing any adhesive that may spill over the outer canal. When four adjacent bumping lines are used, the adhesive is applied to the middle canal. The other two canals then provide two safety trenches on each side.

In the encapsulation structure and method for OLEDs, the height of the bumping line is designed to act as a spacer between the OLED on the substrate and the encapsulation plate for not contacting each other. The bumping lines may be made of hard materials, e.g. ceramic, acrylic resin, and the like, so as to have enough mechanical strength to be spacers. To form the encapsulation bumping lines one may use the thick-film printing method with the printing ink composed of hard materials, such as ceramic, acrylic resin, and the like. This standard method is not only simple to use, but also capable of precisely controlling the pattern, width, and height of the encapsulation bumping lines.

In the encapsulation structure and method for OLEDs, the adhesive is UV-curable and the encapsulation plate is a glass or flexible, UV-transmittable plate. The adhesive is cured by UV light within only about five minutes. In contrast, thermal-cured adhesives are conventionally used along with multiple covers, and they take much longer to cure. Therefore, this new encapsulation process speeds up significantly, and, hence, the throughput increases accordingly.

Because multiple OLEDs with specified locations may be formed on the substrate, the pattern of the encapsulation bumping lines has to be designed accordingly to form canals for housing the adhesive applied. The quantity of the adhesive applied is controlled to avoid too much over-flow, but is still enough to hermetically seal the OLEDs. In the case of three canals, the overflowed adhesive is accommodated inside the empty inner canal to prevent from spillover the enclosed OLEDs.

In the encapsulation method for OLEDs, the encapsulation process is performed within the encapsulation inert-gas chamber, which is one of the many chambers of the OLED manufacturing system. The substrate containing the OLEDs to be encapsulated can be directly transported to encapsulation chamber without ever contacting the air.

The encapsulation apparatus for OLEDs of this invention includes a substrate transporting mechanism (for example, a substrate transporting rail), an encapsulation plate transporting mechanism (for example, an encapsulation plate transporting robot arm), an adhesive applying mechanism (for example, an adhesive applying nozzle), a UV light curing mechanism (for example, a UV lamp), and a hold/press mechanism. First, using the encapsulation plate transporting robot arm, an encapsulation plate with the bumping lines facing-upward is moved to the hold/press mechanism, where it is held steadily by activating vacuum absorption. Then the adhesive is applied appropriately. Third, using the substrate transporting rail, a substrate with OLEDs facing-downward is brought to the position right on top of the encapsulation plate, where the encapsulation plate will be raised by the hold/press mechanism to press against it. With this configuration, the adhesive is cured by UV light illuminated from the UV lamp, located underneath the hold/press mechanism. This completes the hermetical sealing of the OLEDs on the substrate.

### BRIEF DESCRIPTION OF THE DRAWINGS

The above-mentioned and other objects, features, and advantages of the present invention will become apparent with reference to the following descriptions and accompanying drawings, wherein:

FIG. 1 is a schematic diagram showing each step of the encapsulation method for the OLEDs of the present invention;

FIG. 2 is a cross-sectional view showing an example of a single bumping line formed on the encapsulation plate and the encapsulation method using the substrate on the single bumping line;

FIG. 3 is a cross-sectional view showing an example of two adjacent bumping lines formed on the encapsulation plate and the encapsulation method using the substrate on the bumping lines;

FIG. 4 is a cross-sectional view showing an example of three adjacent bumping lines formed on the encapsulation plate and the encapsulation method using the substrate on the bumping lines;

FIG. 5 is a cross-sectional view showing an example of four adjacent bumping lines formed on the encapsulation plate and the encapsulation method using the substrate on the bumping lines;

FIG. 6 is a cross-sectional view showing an embodiment of encapsulation apparatus for OLEDs of the invention;

FIG. 7 is a top view partially showing the portion, around a hold/press position, of the encapsulation apparatus for OLEDs shown in FIG. 6;

FIG. 8 is a cross-sectional view showing a conventional OLED; and

FIGS. 9(a) and 9(b) are pictorial views showing the conventional encapsulation of OLEDs.

### DETAILED DESCRIPTION OF THE PREFERRED EMBODIMENTS

Embodiments for the encapsulation structure, method, and apparatus for organic light-emitting diodes (OLEDs) will be described in detail with reference to the accompanying drawings.

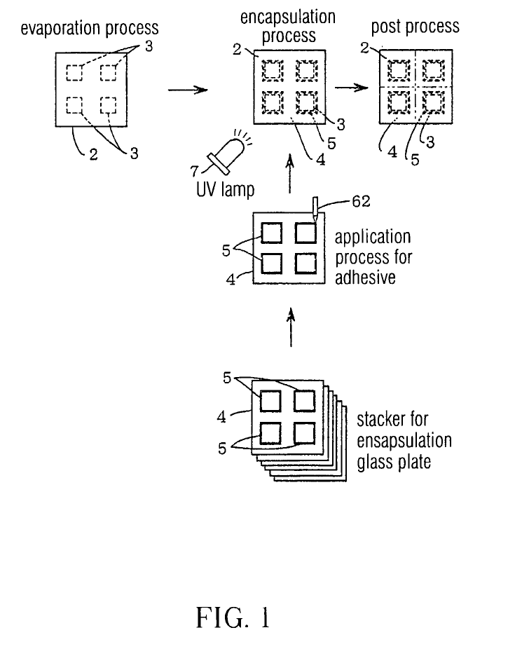

FIG. 1 is a schematic diagram showing each step of the encapsulation method for the OLEDs of the present invention. First, as shown in FIG. 1, four OLEDs 3 faced downward are fabricated on a substrate 2 by an evaporation process in a vacuum apparatus (not shown). Second, in an encapsulation chamber (not shown), an encapsulation plate 4 with its bumping lines 5 faced upward is moved into a hold/press position. To form the encapsulation bumping lines 5 one may use a thick-film printing method with a printing ink composed of hard materials, such as ceramic, acrylic resin, and the like. Then, an adhesive is applied appropriately according to a predetermined pattern by using an adhesive applying nozzle 62 of the encapsulation apparatus as described later. Third, the substrate 2 with OLEDs 3 facing-downward is brought to the position right on top of the encapsulation plate 4, and then is lowered to press against the latter. With this configuration, the adhesive is cured by UV light illuminated from a UV lamp 7, located underneath the hold/press position. The finished product is then removed out for post process.

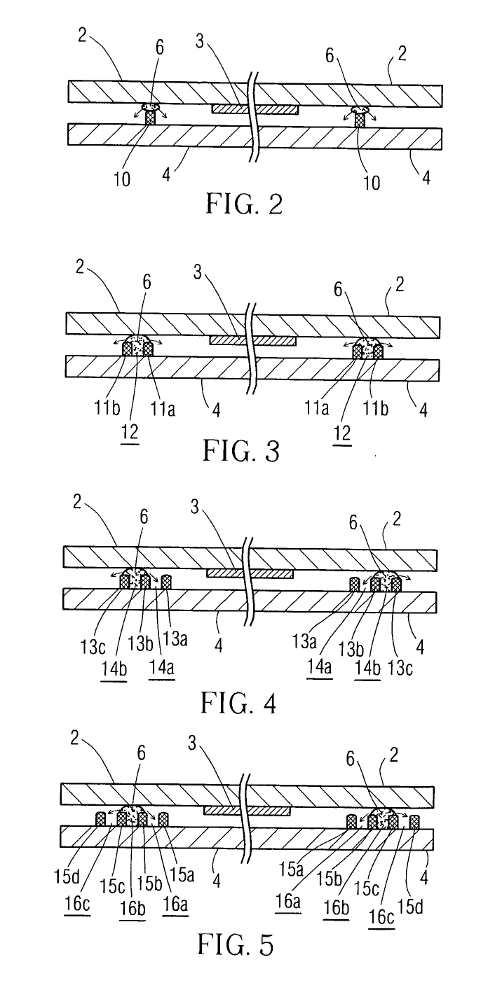

FIG. 2 is a cross-sectional view showing an example of the structure of encapsulation for OLEDs. The bumping line 5 in FIG. 1 appears as a single bumping line 10 here in the form of a closed loop. The adhesive (UV-curable adhesive) 6 composed of UV-curable resin has been applied to the top of the bumping line 10 and cured by the UV light. The cured adhesive 6 glues the substrate 2 and the encapsulation plate 4 together, resulting in the hermetical sealing of the OLEDs 3 by the closed bumping line 10. As shown in FIG. 2, the bumping line 10 serves as a spacer between the substrate 2 and the encapsulation plate 4 for preventing the encapsulation plate 4 from touching the OLEDs 3.

FIG. 3 is a cross-sectional view showing another example of the structure of encapsulation with a canal 12 formed between two adjacent bumping lines (11a and 11b). The UV-curable adhesive 6 is now applied into the canal 12. The quantity of the adhesive applied is controlled to just exceed the wall of the canal 12, but without too much over-flow. When the encapsulation plate 4 is pressed against the substrate 2, the adhesive 6 confined inside the canal 12 is cured by the UV light to make the sealing. The advantage of using the canal 12, instead of the single bumping line 10, is a better control of the over-flow of the adhesive 6.

FIG. 4 is a cross-sectional view showing yet another example of the encapsulation structure. Now, there are three set of bumping lines 13a, 13b, and 13c, which form an inner canal 14a and an outer canal 14b. An appropriate quantity of the adhesive 6 is applied to the outer canal 14b to make sealing. Then, the inner canal 14a can serve as a safety trench to prevent the over-flowed adhesive 6 from spilling over inward to damage the enclosed OLEDs 3.

FIG. 5 is a cross-sectional view showing still another example of the encapsulation structure with four bumping lines 15a, 15b, 15c, and 15d. Three canals 16a, 16b, and 16c are formed between every two adjacent bumping lines, respectively. At this time, an appropriate quantity of the adhesive 6 is applied to the middle canal 16b to make sealing. Again, the inner canal 16a can serve as a safety trench to contain the over-flowed adhesive 6, which flows inward. The new outer canal 16c is used to contain the over flow adhesive 6 which flows outward to avoid coating over the metal electrodes (not shown) that may located outside the bumping lines 15d.

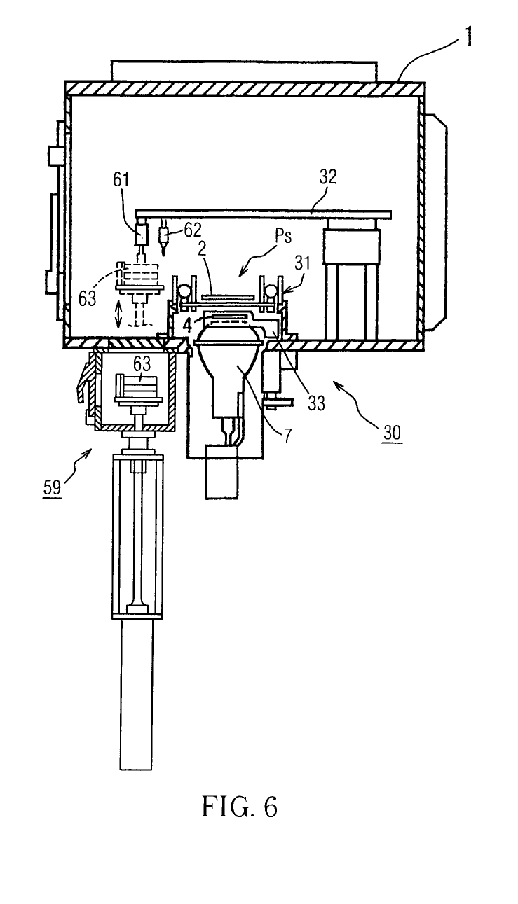

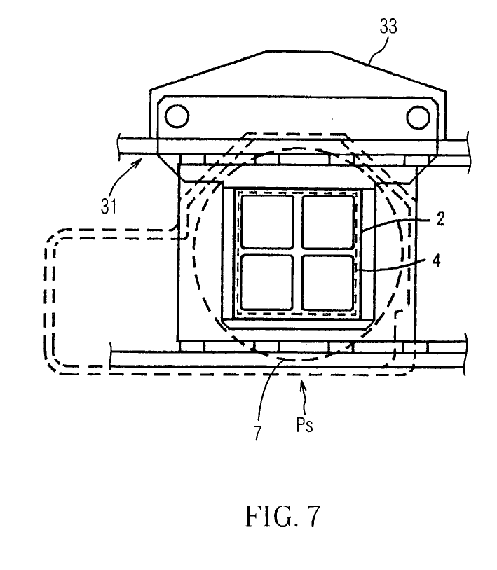

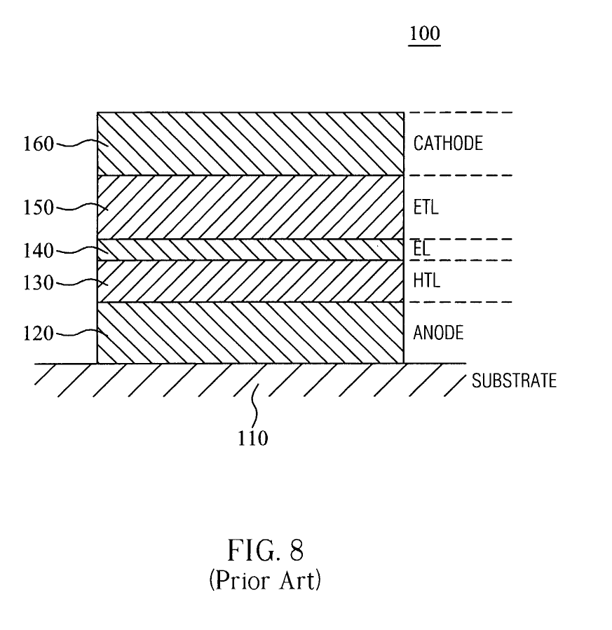

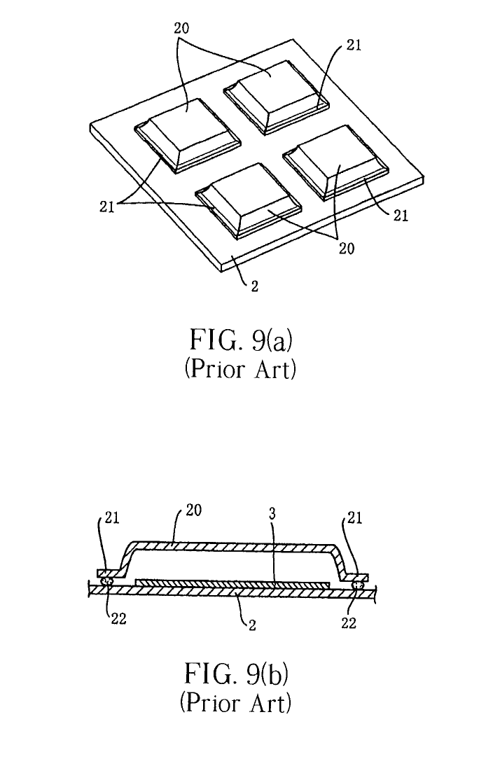

Next, an embodiment of an encapsulation apparatus for OLEDs according to the present invention will be described with reference to FIGS. 6 and 7. FIG. 6 is a cross-sectional view showing an encapsulation apparatus for OLEDs 30 according to one embodiment of the invention. FIG. 7 is a top view partially showing a portion, around a hold/press position Ps, of the encapsulation apparatus for OLEDs 30 shown in FIG. 6.

The encapsulation apparatus for OLEDs 30 shown in FIGS. 6 and 7 mainly includes a substrate transporting rail 31, an encapsulation plate transporting robot arm 32, an adhesive applying nozzle 62, a hold/press mechanism 33, and a UV lamp 7.

Specifically, the substrate transporting rail 31 is operated to move a substrate 2 to a position right over a hold/press position Ps while the encapsulation plate transporting robot arm 32 serves to move an encapsulation plate 4 to the hold/press position Ps. As previously shown in FIGS. 2 to 5, the encapsulation plate 4 is provided with at least one encapsulation bumping line. In this embodiment, the adhesive applying mechanism 62 is supported by the encapsulation plate transporting robot arm 32 for applying the UV-curable adhesive 6 onto the at least one encapsulation bumping line or canals formed between the encapsulation bumping lines. Furthermore, the hold/press mechanism 33 holds the encapsulation plate 4 having been supplied to reach the hold/press position Ps and then presses the encapsulation plate 4 against the substrate 2.

Now, the operation of this encapsulation apparatus for OLEDs 30 is described in detail as follows. First, the encapsulation plates 4 are loaded into an encapsulation plate stack 63, which is outside of the encapsulation inert-gas chamber 1. Then, the encapsulation plates 4 in the loaded stack 63 are moved upward into the chamber 1 by an encapsulation loading mechanism 59 to a position where they will be picked up one-by-one by an encapsulation pick-up head 61 also supported by the encapsulation plate transporting robot arm 32. Second, the encapsulation plate transporting robot arm 32 moves the picked-up encapsulation plate 4 to the hold/press position Ps where it is held by the hold/press mechanism 33. Third, the encapsulation plate transporting robot arm 32 moves the adhesive applying nozzle 62 around appropriately to apply the UV-curable adhesive from a reservoir (not shown) to the canals formed between the bumping lines on the encapsulation plate 4 as described before. Fourth, the substrate 2 along with its OLEDs is moved by the substrate transporting rail 31 to a position right over the hold/press position Ps, where the encapsulation plate 4 will be raised by the hold/press mechanism 33 to press against it. These relative positions can be better seen in a top view, as shown in FIG. 7. In this configuration, the UV lamp 7 is turned on to cure the applied adhesive on the encapsulation plate 4 (a transparent plate) for the hermetical sealing of the OLEDs on the substrate 2.

What is claimed is:

1. An encapsulation structure for organic light-emitting diodes comprising:
a hard or flexible substrate;
at least one organic light-emitting diode formed on the substrate;
a glass or flexible, UV-transmittable encapsulation plate formed with at least one encapsulation bumping line each in a form of a closed loop for enclosing said at least one organic light-emitting diode; and
an adhesive for adhering said at least one encapsulation bumping line to said substrate thereby encapsulating said at least one organic light-emitting diode.

2. The encapsulation structure according to claim 1, wherein said at least one encapsulation bumping line is applied, on the top thereof, with said adhesive.

3. The encapsulation structure according to claim 1, wherein between adjacent two of said at least one encapsulation bumping line is formed with at least one canal which is applied with said adhesive.

4. The encapsulation structure according to claim 1, wherein said at least one encapsulation bumping line is formed of a hard material selected from the group consisting of ceramic and acrylic resin.

5. The encapsulation structure according to claim 1, wherein said adhesive is UV-curable and said encapsulation plate is transparent such that said adhesive can be illuminated by UV light and cured to hermetically adhere said encapsulation plate to said substrate.

6. An encapsulation method for organic light-emitting diodes comprising:
forming at least one organic light-emitting diode on a substrate;
forming at least one encapsulation bumping line each in a form of a closed loop on an encapsulation plate;
applying an adhesive to said at least one encapsulation bumping line;
adhering said at least one encapsulation bumping line to said substrate thereby encapsulating said at least one organic light-emitting diode.

7. The encapsulation method according to claim 6, wherein said adhesive is applied to the top of said at least one encapsulation bumping line.

8. The encapsulation method according to claim 6, wherein said adhesive is applied to at least one canal formed between adjacent two of said at least one encapsulation bumping line.

9. The encapsulation method according to claim 6, wherein said adhesive is prevented from flowing into said at least one organic light-emitting diode when said at least one encapsulation bumping line is adhered to said substrate by controlling the quantity of said adhesive applied.

10. The encapsulation method according to claim 6, wherein said adhesive is prevented from flowing into said at least one organic light-emitting diode when said at least one encapsulation bumping line is adhered to said substrate by further providing an inner canal between said at least one organic light-emitting diode and said adhesive applied to accommodate an overflowed portion of said adhesive applied.

11. The encapsulation method according to claim 6, wherein said at least one encapsulation bumping line on the encapsulation plate is formed of a hard material selected from the group consisting of ceramic and acrylic resin by a thick-film printing method.

12. The encapsulation method according to claim 6, wherein said adhesive is UV-curable and said encapsulation plate is transparent such that said adhesive can be illuminated by UV light and cured to hermetically adhere said encapsulation plate to said substrate.

13. The encapsulation method according to claim 6, wherein the steps of forming at least one encapsulation bumping line each in a form of a closed loop on an encapsulation plate, applying an adhesive to said at least one encapsulation bumping line, and adhering said at least one encapsulation bumping line to said substrate thereby encapsulating said at least one organic light-emitting diode are performed within an encapsulation inert-gas chamber.

14. An encapsulation apparatus for organic light-emitting diodes comprising:
a substrate transporting mechanism for moving a substrate formed with at least one organic light-emitting diode to a position over a hold/press position;
an encapsulation plate transporting mechanism for moving an encapsulation plate to the hold/press position, the encapsulation plate being provided with at least one encapsulation bumping line for enclosing said at least one organic light-emitting diode, and the encapsulation bumping line being applied with an adhesive; and
a hold/press mechanism for holding said encapsulation plate supplied to the hold/press position and for pressing said encapsulation plate against said substrate.

15. The encapsulation apparatus according to claim 14, wherein said encapsulation plate is transparent and said adhesive is UV-curable.

16. The encapsulation apparatus according to claim 15, further comprising:
a UV light curing mechanism located underneath said hold/press mechanism,
wherein a UV light from said UV light curing mechanism passes through said encapsulation plate to cure said UV-curable adhesive when said hold/press mechanism presses said encapsulation plate against said substrate.

17. The encapsulation apparatus according to claim 14, wherein said substrate transporting mechanism moves said substrate with said organic light-emitting diodes facing downward, and said hold/press mechanism holds said encapsulation plate with said at least one encapsulation bumping line facing upward.

18. The encapsulation apparatus according to claim 14, further comprising:
an encapsulation pick-up head supported by said encapsulation plate transporting mechanism for picking up said encapsulation plate one-by-one from an encapsulation plate stack.

19. The encapsulation apparatus according to claim 14, further comprising:
an adhesive applying mechanism supported by said encapsulation plate transporting mechanism for applying said adhesive to said at least one encapsulation bumping line.

20. The encapsulation apparatus according to claim 14, wherein said substrate transporting mechanism, said encapsulation plate transporting mechanism, and said hold/press mechanism are all arranged within an encapsulation inert-gas chamber.
